(19) United States
(12) Patent Application Publication
(10) Pub. No.: US 2015/0112720 A1
(43) Pub. Date: Apr. 23, 2015

(54) STANDARDIZED ELECTRONIC TWO-WAY DATA TRANSFER HEALTHCARE FORM SYSTEM AND METHOD

(71) Applicant: Jose Gil Aragones Macion, Fontana, CA (US)

(72) Inventor: Jose Gil Aragones Macion, Fontana, CA (US)

(21) Appl. No.: 14/517,840

(22) Filed: Oct. 18, 2014

Related U.S. Application Data
(60) Provisional application No. 61/892,964, filed on Oct. 18, 2013.

(51) Int. Cl. G06F 19/00; H04L 29/08

(52) U.S. Cl. CPC G06F 19/322; H04L 67/10
USPC 705/3

(57) ABSTRACT

A system and methods of transferring patient medical data between two or more healthcare facilities using disparate electronic medical record systems. The novel system and methods use a selectively populated standardized electronic two-way data transfer healthcare form to securely transfer medical data between the incompatible electronic medical records systems.

### FIELD

This invention relates generally to a system and method of data transfer and more specifically to a system and method of data communication between Electronic Medical Record (EMR) systems using a Standardized Electronic Two-Way Data Transfer Healthcare Form.

### BACKGROUND

Medical care is a complicated multi-trillion dollar industry. A substantial cost of medical care is incurred as administrative costs. As much as 25-30% of medical practice revenues are spent on administration. A significant factor of administrative cost is new technology. New technology allows doctors to see more patients and allows medical groups to work more efficiently to provide better care for their members.

However, investing in new technology is costly. Technology is the most significant driver of healthcare spending which increases over time. For example, installing and implementing electronic health records is expensive, often as much as $25,000 per doctor for a system. In addition many electronic healthcare record systems charge a monthly subscription fee on top of the initial startup fee. Electronic medical records require significant resources.

Medical practices have little choice but to shoulder this administrative burden because new privacy laws, insurance requirements, and the sheer size of medical groups require more accurate and comprehensive medical record keeping.

FIG. 1 is a Use Case Diagram illustrating the typical role of patient, doctor, nurse and healthcare administrator. The healthcare administrator has become an essential part of the healthcare team. Each person in the diagram performs their role and fills out forms and documents that must be kept in the patient's medical records. All of these forms must be administered by the healthcare administrator.

FIG. 2-4 are flow diagrams illustrating the As-Is Process of a typical visit to a Health Care Facility (HCF). In FIG. 2, the visit is a scheduled visit with a Primary Care Doctor (PCP). FIG. 3 illustrates an unscheduled visit to the Emergency Room. FIG. 4 illustrates a typical patient referral to a specialist.

In each of these flow diagrams, there are extensive administrative burdens. New patients are required to complete and submit forms identifying themselves and their insurance carrier. This information must be manually inputted and stored as an Electronic Medical Record (EMR). The requirement for the patient to fill out standard identification forms each and every visit to a new HCF is redundant and inefficient. This is especially inconvenient for a patient in FIG. 3 during an unscheduled visit to the ER. A patient seeking emergency medical care should not have delays receiving their care due to administrative reasons.

In the past medical records were kept as paper files in a doctor's office or hospital file room. As computers became ubiquitous, paper files were replaced with electronic medical records. Instead of a physical medium of storage, medical records are now mainly kept as computer data that can be theoretically shared between multiple medical groups. However, for many reasons, even though medical records are kept on an easily transportable medium, they are generally still kept locally in the doctor's office. Ironically medical records are still converted to physical paper files when a patient decides to switch medical groups.

One of the main barriers prohibiting an exchange of medical records between different medical groups is the use of proprietary medical records systems. Many medical groups use ad hoc medical record systems specifically made for their office needs. These proprietary medical records systems record patent information in databases unreadable by other medical records systems. In order to transfer a patient's medical records to another medical group, the records have to be printed out and re-entered into the medical record system of the new medical group.

Even among hospitals in the same medical group, disparate EMRs may exist. Hospitals newly acquired by medical groups may not be upgraded with the medical groups EMR system due to cost and retraining resistance.

One of the primary complaints about proprietary electronic medical records systems is the initial learning curve. Physicians change jobs just like any other employee. Learning a new medical record system is time consuming and takes away from their already limited time with a patient. Physicians see, on average, a patient every 15 minutes. Each minute lost fumbling with a new medical record system is one less minute actually treating the patent.

Another problem with proprietary medical record systems is accessing the medical records in an emergency. Not all medical needs will conveniently take place in a clinic of the patient's medical group. During vacation or business travel a patient may be outside the service area of their medical group. In such situations, the lack of easily shared medical records may cause problems ranging from inconvenience, e.g. re-entering basic information, to life threatening, e.g. existing medication conflicts and drug allergies.

Another barrier to adopting a single medical record system is competition. Competition between institutions and between providers produces a disincentive for information sharing. Large medical groups spend tens of millions of dollars creating a proprietary medical records system. Such a large investment naturally fosters an implicit belief that institutions must protect their investment by preventing the distribution of those records to other institutions.

There exists a need for comprehensive “real-time” protected health information (PHI) at the clinicians' fingertips. This will effectively enhance quality of care, physician performance, and patient outcomes; while substantially mitigating risk and reducing administrative costs, redundant data entry, paper usage, and facsimiles.

### SUMMARY

An aspect of the invention generally relates to a system and method of transferring medical data between disparate medical record systems using a standardized electronic two-way data transfer healthcare form. In one embodiment of the invention, the invention is a Requestor Initiated (R.I.) system and method of transferring medical data between two or more medical facilities. In another embodiment the invention is a Sender Initiated (S.I.) system and method of transferring medical data between two or more medical facilities.

In other embodiments of the invention a standardized electronic two-way data transfer healthcare form is selectively populated with a patient's medical records and then transferred to a requesting Healthcare Facility or pushed to a receiving Healthcare Facility.

Embodiments of the invention integrate with existing EMRs to generate a standardized electronic two-way data transfer healthcare form with the patient's medical records. The standardized electronic two-way data transfer healthcare form provide a secure means of transferring medical records between disparate EMR systems.

### BRIEF DESCRIPTION OF THE DRAWINGS

FIG. 1 is a Use Case Diagram illustrating the typical role of patient, doctor, nurse and healthcare administrator.

FIG. 2 is a flow diagram illustrating a typical scheduled visit with a primary care doctor.

FIG. 3 is a flow diagram illustrating an unscheduled visit to the Emergency Room.

FIG. 4 is a flow diagram illustrating a typical patient referral to a specialist.

FIG. 5A is a process flow diagram illustrating transfer of data between two EMR facilities in an embodiment of the invention.

FIG. 5B is a process flow diagram of a SETH form query of EMR facilities in a network

FIG. 6A is a process flow diagram illustrating requester initiated transfer of data between two EMR facilities in an embodiment of the invention.

FIG. 6B is a supplemental process flow diagram illustrating requester initiated transfer of data between two EMR facilities.

FIG. 7A is a process flow diagram illustrating sender initiated transfer of data between two EMR facilities in an embodiment of the invention.

FIG. 7B is a supplemental process flow diagram illustrating sender initiated transfer of data between two EMR facilities.

FIG. 8A-8S illustrate exemplary data fields that may be found in a SETH form.

### DETAILED DESCRIPTION OF THE EXEMPLARY EMBODIMENTS

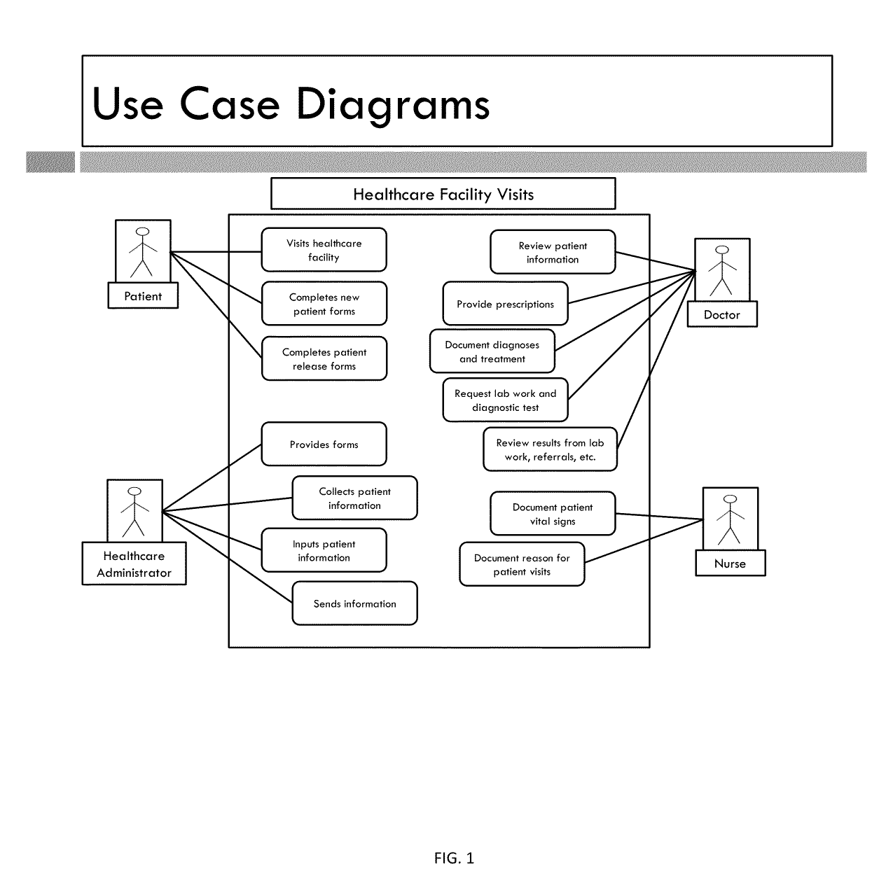

In FIG. 1, a Use Case Diagram of a Healthcare Facility (HCF) Visit, a patient visits a healthcare facility. For the purposes of this Application an HCF may be a hospital, doctor's office, lab, clinic, etc. The patient generally has to complete new patient forms if this is their first visit to a particular HCF. During the initial visit, the patient may also be required to fill out patient release forms.

Continuing with FIG. 1, a doctor reviews the patient information as part of his limited time with the patient. Bear in mind that the patient information may be incomplete as it is dependent on what the patient may remember of their medical history. Thus the doctor may have used up vital time better spent diagnosing the patient to review a medical history that may not even be complete.

Much of the process illustrated in FIG. 1 could be reduced and made more efficient if the patient's former HCF could transfer the patient's medical records to the new HCF. The patient would save a lot of time not having to fill out redundant medical information on the new patient forms. Similarly, a patient release form may be partially filled out with identifying information awaiting only the patient's signature.

Perhaps even more beneficial, with a transferring a patient's medical record, a new doctor would have a complete medical record at his or her disposal. With a complete medical record, the new doctor may be able to consider what procedures and medicines have already been prescribed, what medicines the patient is allergic to, and what medicines may cause contraindication with the patient's prescription history.

A transferred patient medical record would also lessen the workload of the Healthcare Administrator in FIG. 1. The Healthcare Administrator's role providing the initial forms, collecting patient information, inputting the patient's information, and sending that information off to the next HCF may be automated by embodiments of the invention.

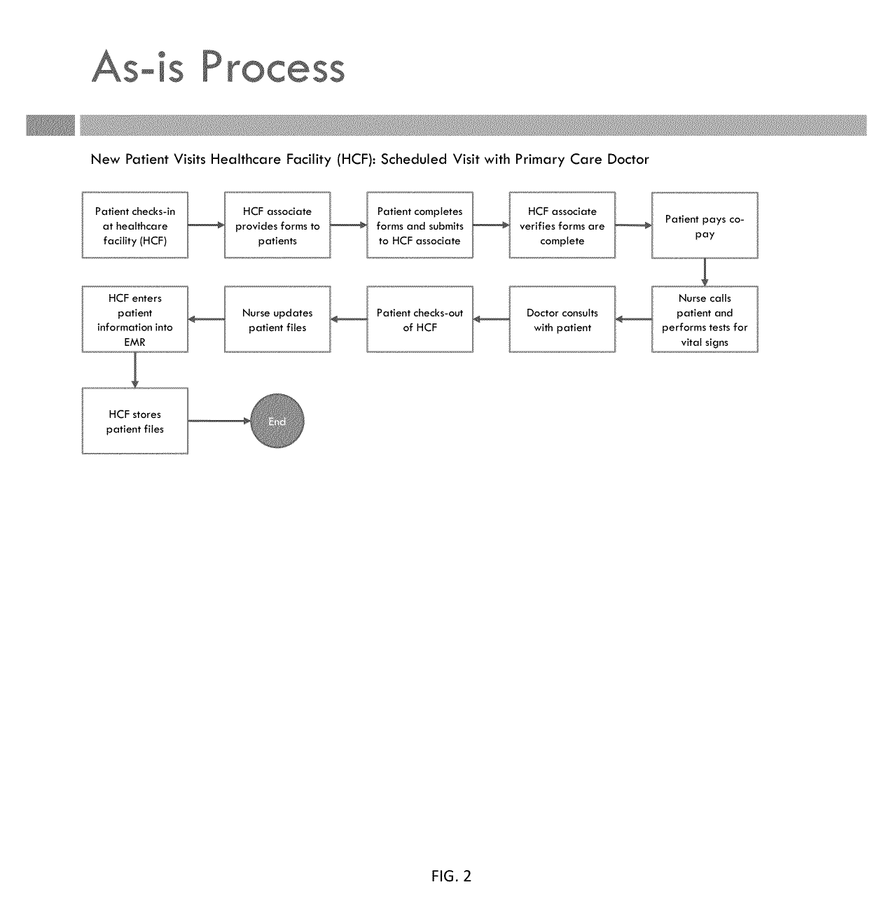

FIG. 2 is a process flow diagram illustrating a scheduled visit to the patient's Primary Care Physician (PCP). Much like FIG. 1, the patient is required to fill out many forms that must be manually entered by an HCF associate. As in FIG. 1, the process may be streamlined by embodiments of the invention by transferring the patient's medical record from the old HCF to the new HCF.

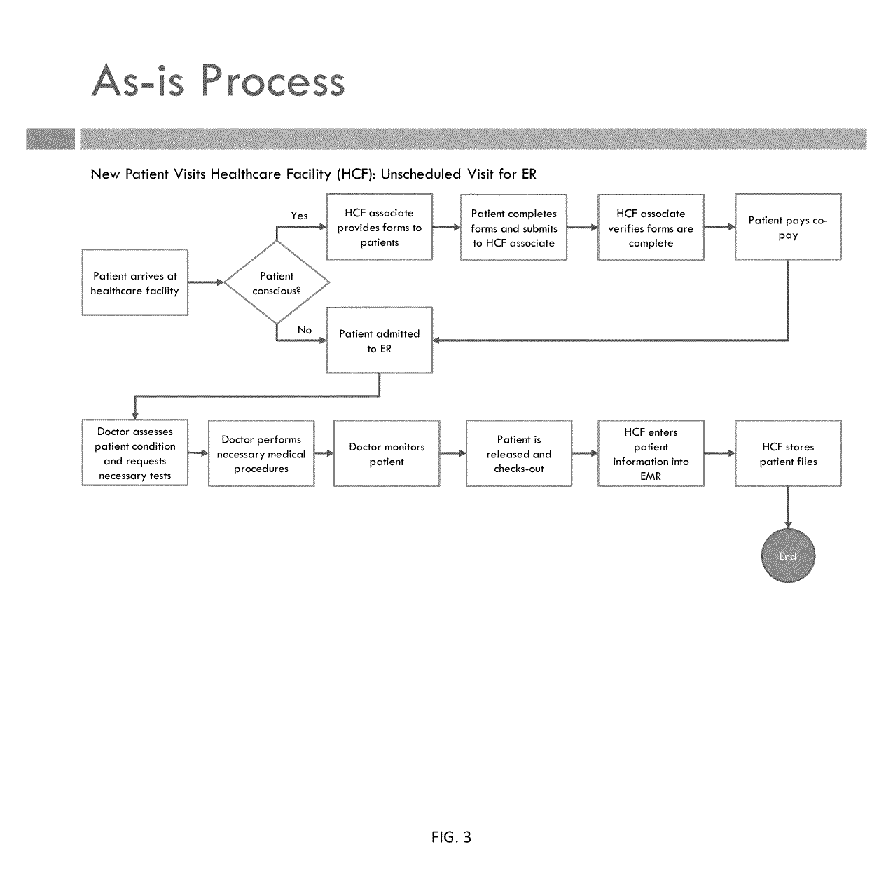

FIG. 3 is a process flow diagram illustrating an unscheduled visit to an Emergency Room (ER). Applicant's invention would be even more beneficial in this scenario. Unlike the first two scenarios, a visit to the ER is generally urgent in nature. The patient has hurt himself or has some symptoms that need immediate medical attention. In such a situation, the patient is not inclined to fill out redundant identification and release forms. Yet, anyone who has visited an ER will know that unless the situation is life threatening, the patient is still required to fill out medical forms prior to being treated.

In another embodiment of the invention that may be beneficial, tests and lab requests from the attending physician may be facilitated faster and more accurately through Applicant's invention. In FIG. 3, the physician assesses the patient's condition and requests necessary tests. In some smaller HCFs, labs are not on-site and may not even be in the same Medical Group. Thus, like the transfer of a patient's medical record by printing and physically bringing the paper files to the next HCF, lab requests may need to be ordered by paper requests. Embodiments of the invention may facilitate faster lab requests by transferring and documenting the requests electronically. Less papers being physically mailed or carried and less data being re-entered will likely reduce lost paperwork and data entry errors.

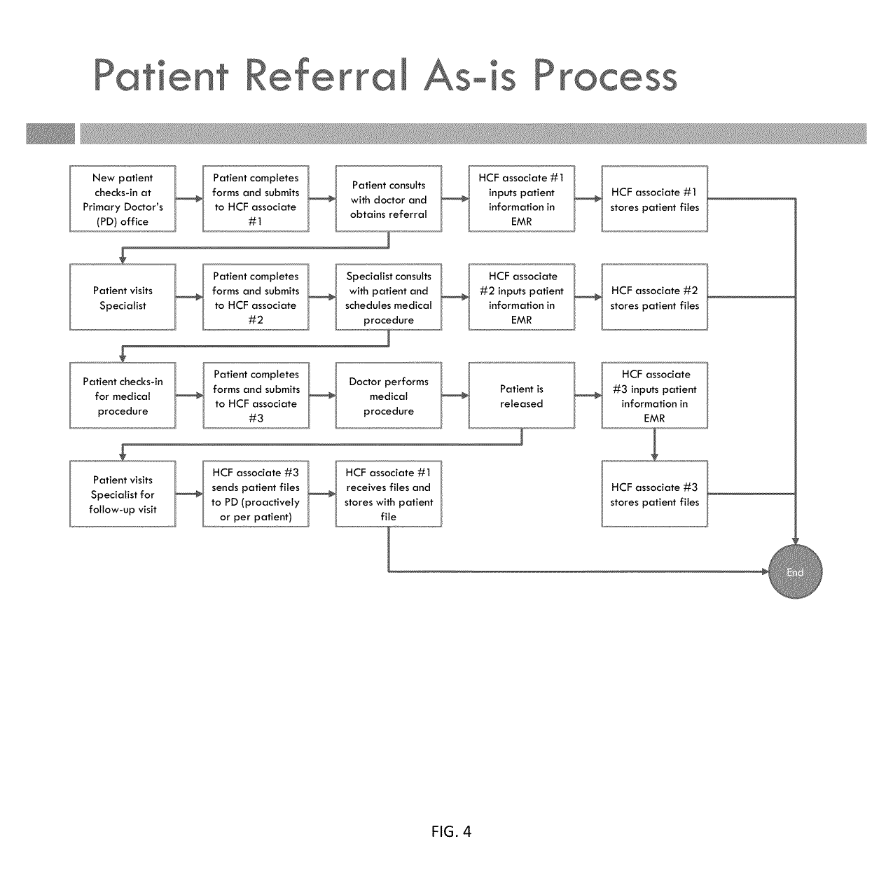

FIG. 4 is a process flow diagram illustrating an As-Is Process for patient referral to a Specialist. In this flow diagram, there are even more complex layers of administration needed before a patient can actually see the specialist. The patient may have to complete two sets of redundant medical forms, one for the referring physician and one for the specialist. Each set of form may require a HCF associate to administer the forms and enter them into the EMR. Furthermore, the diagnosis and treatment provided by the specialist may need to be relayed back to the referring physician. Much of this paperwork may be eliminated by the electronic transfer of the patient's medical record by Applicant's invention.

In one embodiment of the invention parts of the patient's medical record is transferred selectively. In the case of a specialist, only parts of the patient's medical record pertaining to that specialist may be initially transferred. For example, if the PCP is referring the patient to a dermatologist, the patient's history of treatment for skin disorders may be transferred but the PCP may choose not to send the patient's cardiac history.

As previously mentioned, embodiments of the invention allow HCFs to communicate with each other lessening the administrative burden of presenting and inputting redundant medical forms to patients at each office visit. One method of facilitating communications between HCFs would be for every HCF to use the same EMR software. Forcing standardized software on every HCF is problematic however. As noted above, EMR software is generally proprietary software customized to the needs of each HCF. Medical Groups pay millions of dollars for their EMR software and are very protective of their investment.

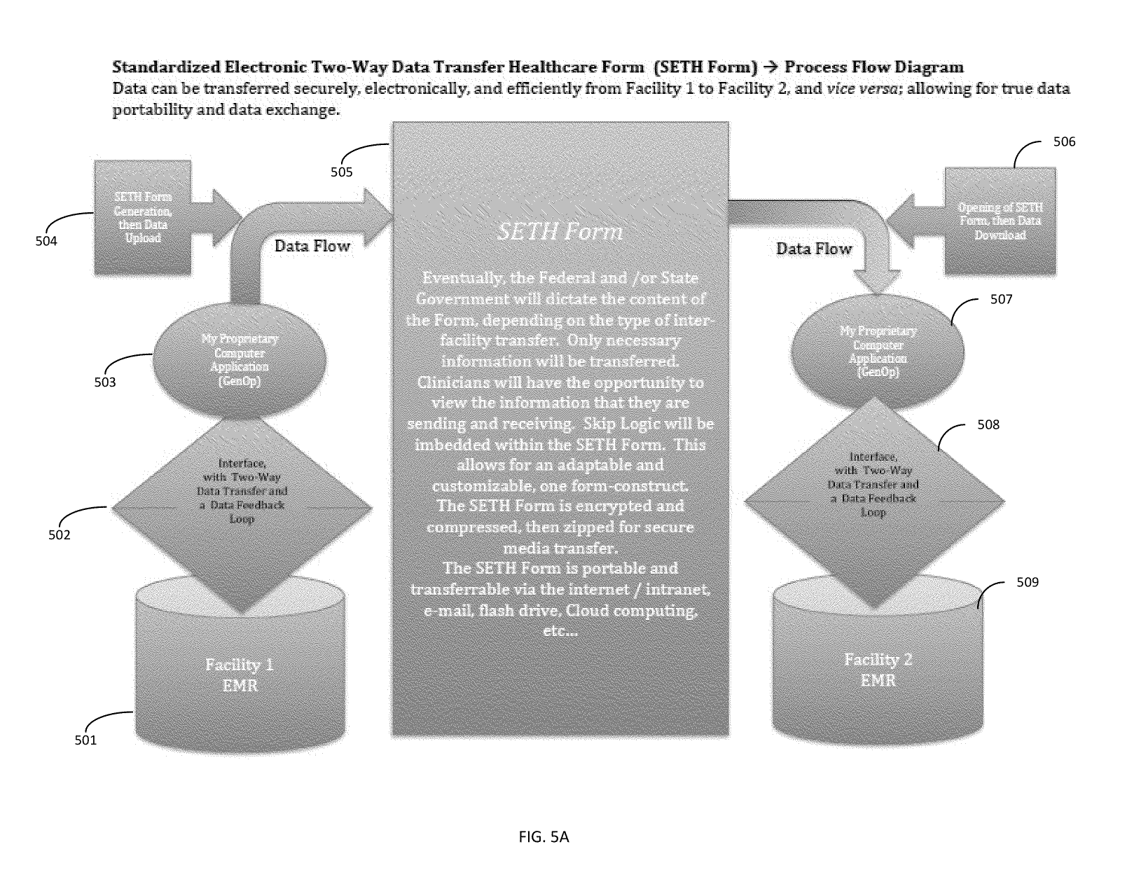

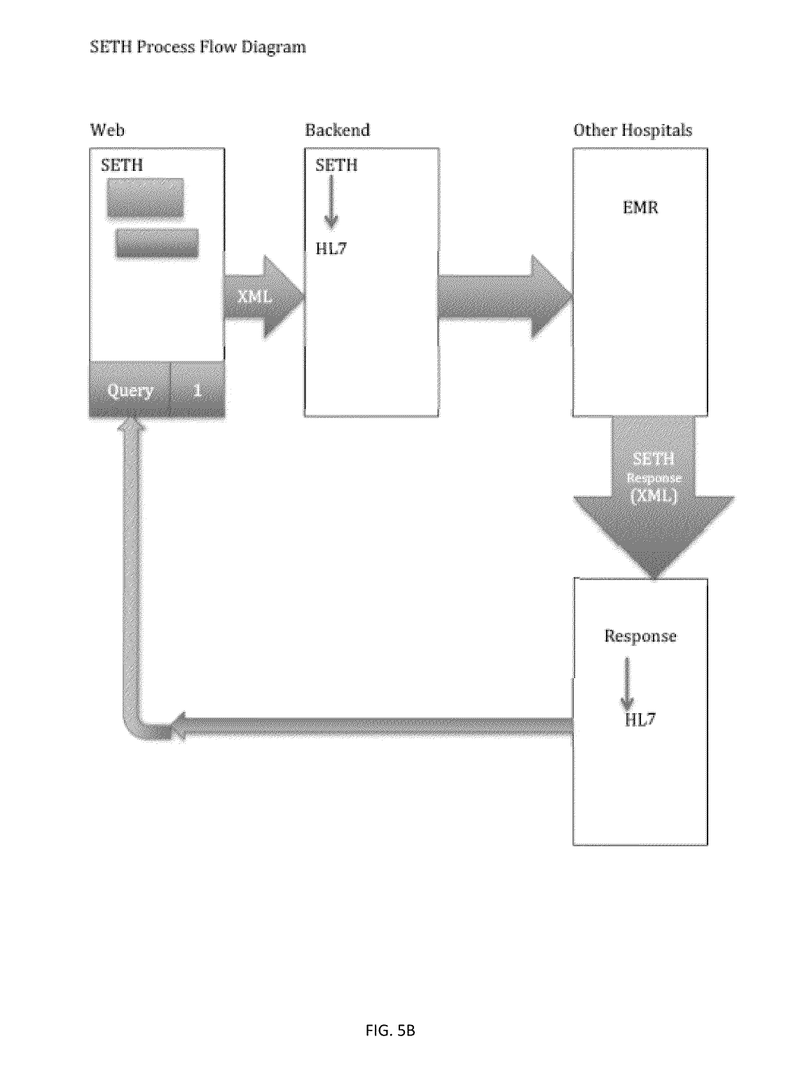

A novel solution resolving the problem of disparate EMR software is presented by Applicant's invention. Applicant's invention provides a bridge between two disparate EMR systems allowing the display and selective transfer of data. FIG. 5A is a process flow diagram of Applicant's novel system and method of providing communication between two disparate EMR systems.

In FIG. 5A, EMR Facility 501 (hereinafter “Facility 501”) may be a HCF such as a hospital, clinic, lab, or doctor's office. EMR Facility 509 (hereinafter “Facility 509”) is another HCF. Facility 501 and Facility 509 use disparate EMR software from different software vendors, thus normally cannot connect and communicate with each other.

In order to facilitate communication between Facility 501 and 509 Interface modules 502, 508 may be coupled to the EMR's of Facility 501 and Facility 509 respectively. Interface Modules 502, 508 provide two-way data transfer and data feedback loop. In embodiments of the invention a Health Level Seven International (HL7) standard is used in the Interface Modules 502,508.

Health Level Seven International (HL7) is a not-for-profit, ANSI-accredited standards developing organization dedicated to providing a comprehensive framework and related standards for the exchange, integration, sharing, and retrieval of electronic health information that supports clinical practice and the management, delivery and evaluation of health services. HL7's 2,300+ members include approximately 500 corporate members who represent more than 90% of the information systems vendors serving healthcare.

If Facility 501, 509 are not HL7 compatible, Applicant's invention may provide a custom interface module 502, 508 specifically adapted to Facility 501, 509's EMR system. One purpose of the interface modules 502, 508 is to interface with the EMR system and provide an HL7 compatible patient data. HL7 does not provide software and HL7 patient data is generally flat data and cannot be readily read by a person.

In order to make use of the HL7 patient data generated by the Interface Modules 502, 508, GenOp™ Application 503, 507 couples to the Interface Modules 502, 508 and translates and displays the HL7 patient file into a human readable format. GenOp™ Application 503 translates the HL7 compliant patient data and uploads and displays it as a Standardized Electronic Two-Way Data Transfer Healthcare Form (SETH Form 505) at SETH Form generator 504. SETH form generator 504 may be viewed and the fields of the SETH Form may be selected by by the transferring Facility 501.

SETH Form 505 may allow Facility 501 to select portions of the patent's EMR to transfer. This selective transfer function may be manually selected or may be automated depending on the type of receiving Facility 509. For example, if Facility 509 is a dermatologist's office, they may not need the complete patient's medical records, and thus would receive only portions pertaining to their practice.

The SETH Form 505 is a customizable one form construct that displays the patient's medical records. Skip logic may be embedded in the SETH Form 505 to enhance usability. Skip logic allows certain fields to be skipped if they are not pertinent. For example, if the patient is male, skip logic may allow the SETH form 505 to exclude fields regarding pregnancy.

SETH Form 505 will be encrypted and compressed for secure media transfer via internet, intranets, email, flash drive, cloud computing, etc.

FIG. 5B is process flow diagram illustrating the SETH query process. In an embodiment of the invention, a query is generated through the web based GenOp™ Application. On the backend, the GenOp™ Application will search the local SETH Form for the data needed. If the data is not available locally, a query will be sent to EMRs of HCFs in the network. A response with the queried data will be translated to HL7 compliant patient data and populate a SETH Form to be sent back to the GenOp™ Application.

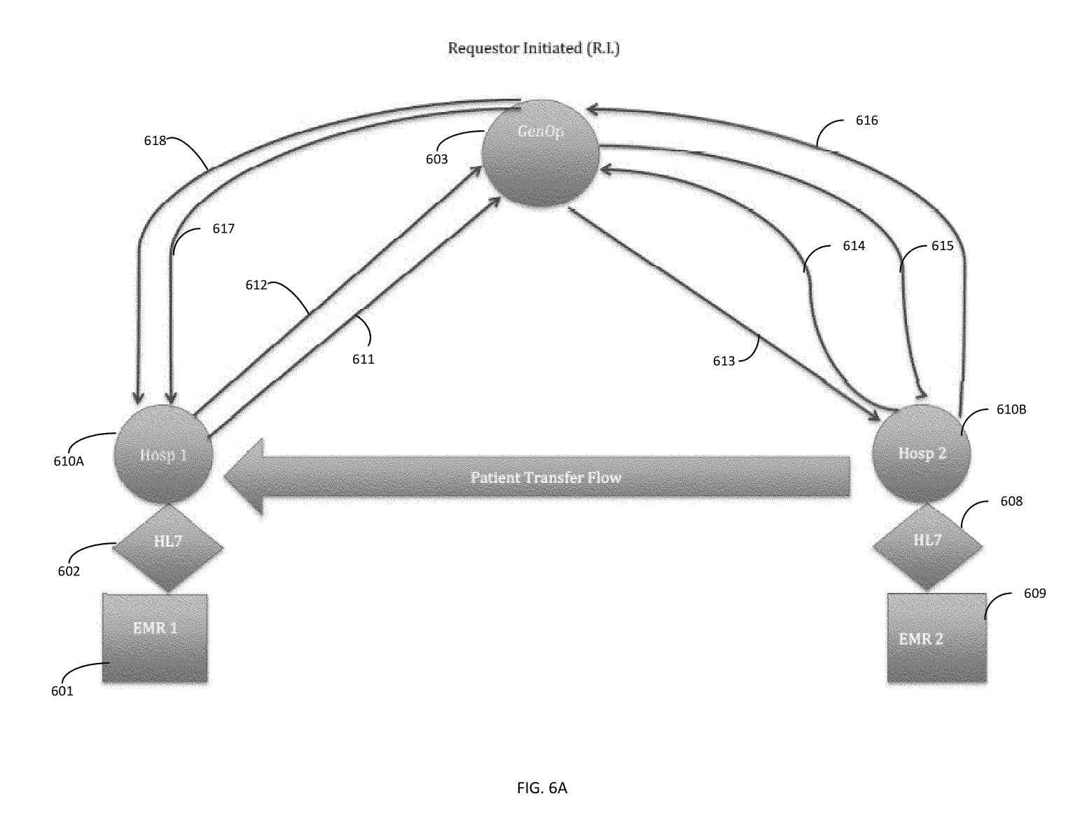

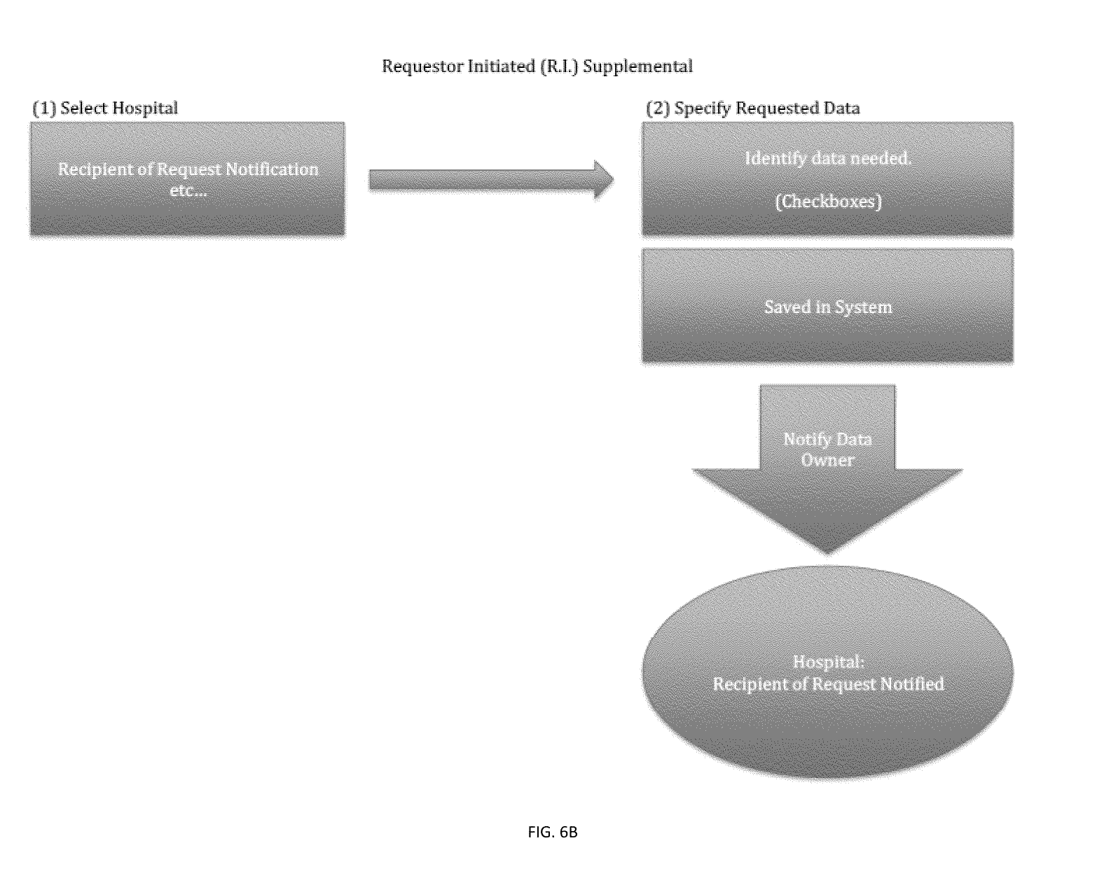

FIG. 6A is a flow diagram of a Requestor Initiated Process according to one embodiment of the invention. In this scenario Hospital 610A has received a patient from Hospital 610B. Hospital 610A and Hospital 610B have different and incompatible EMR 601 and 609 respectively. Hospital 610A initiates a request for patient medical records. Hospital 610A is the data requestor and Hospital 610B is the data owner.

In step 611, the data requestor logs into the GenOp™ Application using a secure login process. In step 612, the data requestor chooses the data owner e.g. Hospital 610B and specifies the data needed. In step 613, GenOp™ Application 603 notifies Hospital 610B that a request is pending. In step 614, the data owner logs in and views the request. Step 615 the data owner authorizes the data upload. Step 616, the data is uploaded to a SETH form and the data requestor is notified of the upload. Step 617 notifies the data requestor that the data has been successfully transferred to GenOp™ 603. In step 618, the patient's data is downloaded to Hospital 610A.

FIG. 6B is a flow diagram providing supplemental information of process step 612 of FIG. 6A. The data requestor chooses the data owner in step 1 and then identifies the specific data needed in step 2. In this embodiment the data requested is selected by checkboxes but other methods of specifying the data requested may be used. Once the data needed has been identified, the data owner is notified.

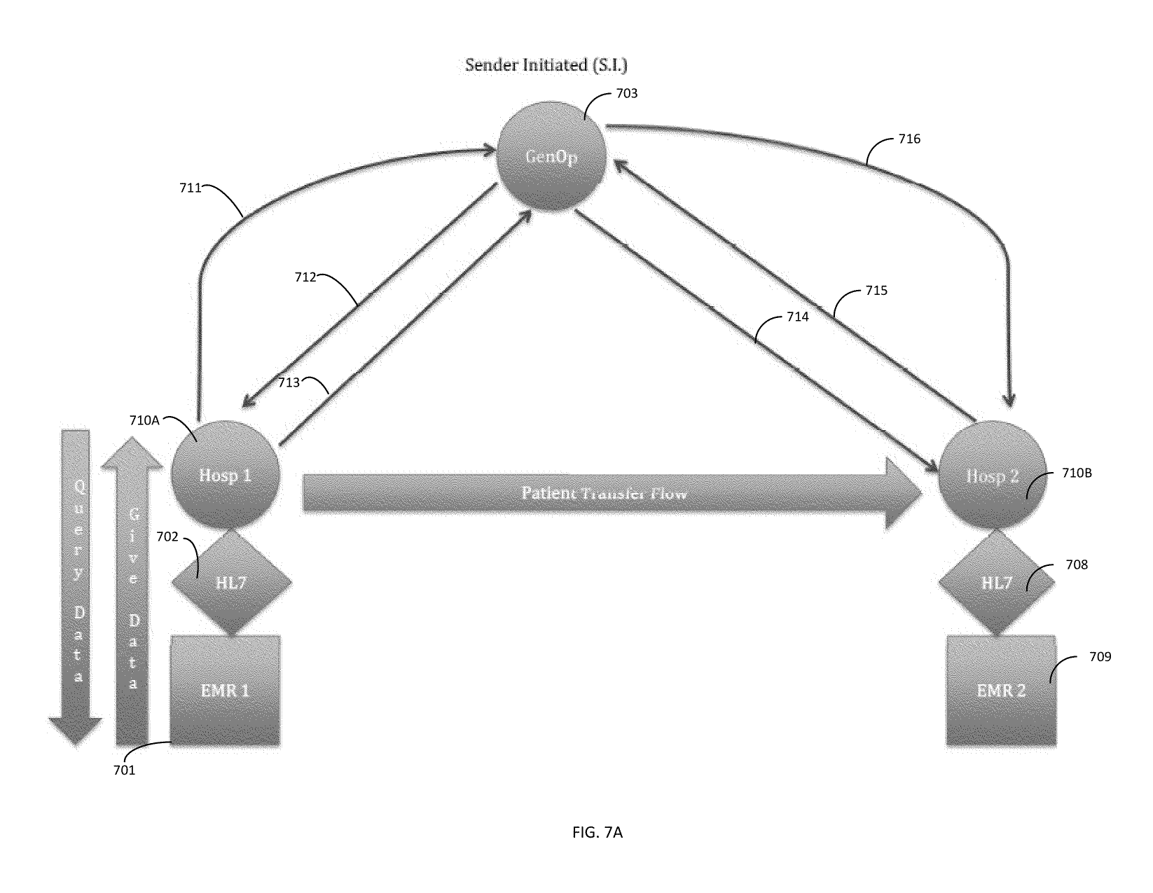

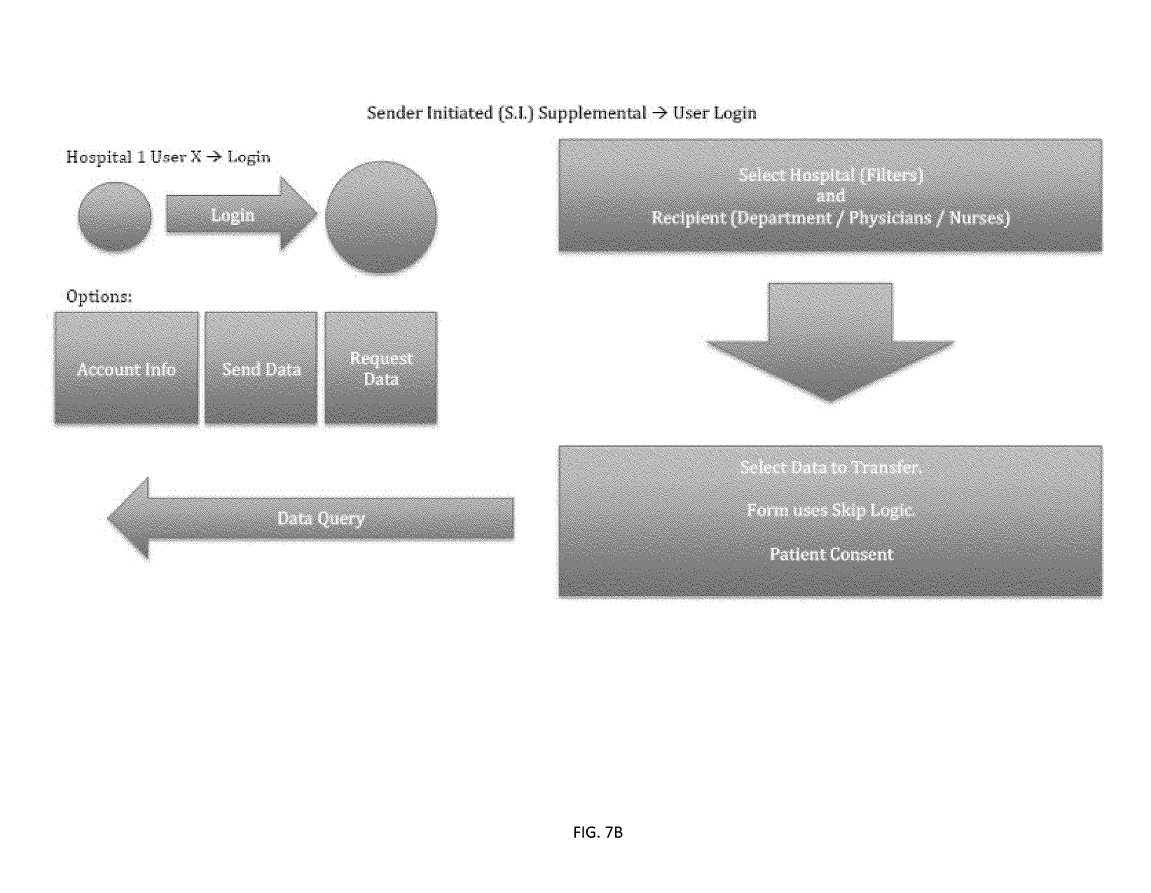

FIG. 7A is a flow diagram of a Sender Initiated Process according to one embodiment of the invention. In this scenario Hospital 710A is sending a patient to Hospital 710B. Hospital 710A and Hospital 710B have different and incompatible EMR 701 and 709 respectively. Hospital 710A initiates a push of the patient's medical records.

In step 711, the administrator at Hospital 710A logs into the GenOp™ Application 703 using a secure login process. In step 712, GenOp 703 queries Hospital 710A to specify the data the Hospital 710A is sending. In step 713, Hospital 710A pushes the selected data to GenOp 703. GenOp 703 then notifies the receiving Hospital 710B that a transfer is pending in step 714. An administrator at Hospital 710B logs into the GenOp 703 and views the transfer at step 715. Hospital 710B approves the data transfer and the SETH Form, HL7 file, or any electronic medical record file is downloaded to Hospital 710B.

FIG. 7B illustrate supplemental information to the Sender Initiated Process of FIG. 7A according to an embodiment of the invention. After log in, the user may have the option of viewing their account, sending data, or requesting data. If the user decides to send or request data, they may select a HCF to send data to (or request data from) and further select the departments, physicians, or nurses for this data push or request.

In another embodiment of the invention, two Healthcare Facilities (HCF, such as a Hospital, Doctor's Office, etc.) have subscribed to GenOp Software, and are sharing Patient A's information. An HL7 file, which contains the patient data, is extracted from HCF's (#1) EMR, via the HL7 interface. The HL7 file's data is uploaded and stored within the GenOp-generated SETH Form.

The SETH Form, which may be an XML file but is not limited to an XML file, will travel from one EMR to another EMR via the internet, after it has been reviewed and authorized by the appropriate HCF associate (i.e. clinician, physician). When the SETH form arrives at HCF's (#2) EMR, an alert will be sent via text or email notifying a GenOp user (i.e. HCF associate) of the data received.

The GenOp user, at HCF #2, will log in and select the case from the queue, to review the information. Once GenOp user, at HCF #2 verifies the patient information is correct, then the GenOp user (HCF #2) authorizes GenOp to download the data from the SETH Form, to their EMR. The patient data on the SETH form is re-converted into an HL7 file, for download.

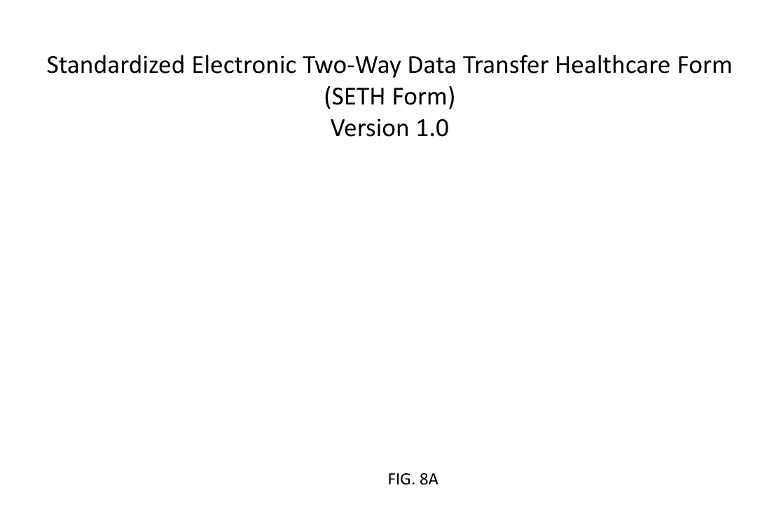

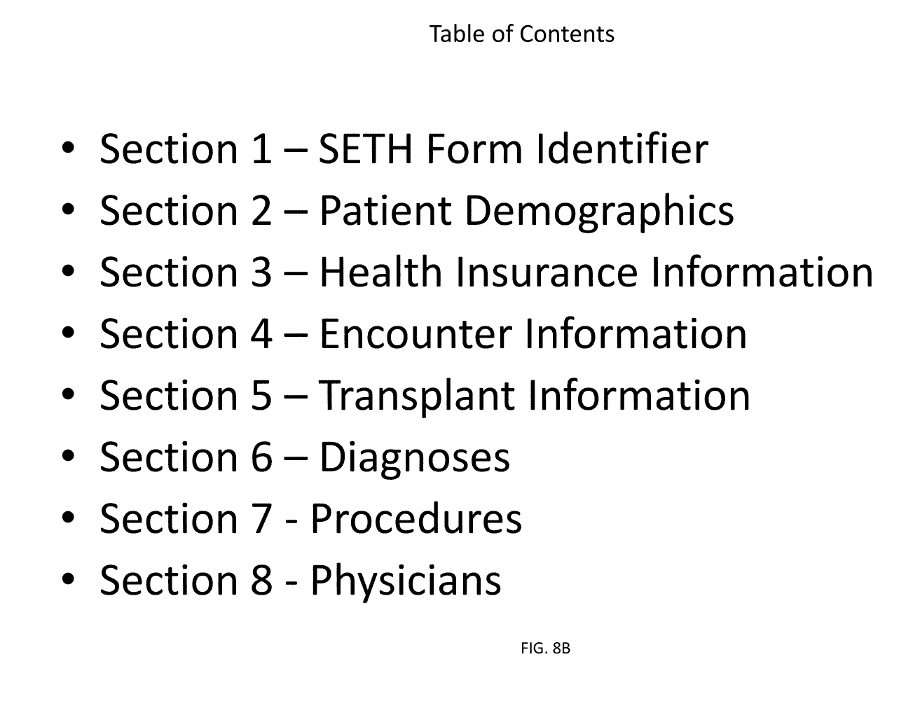

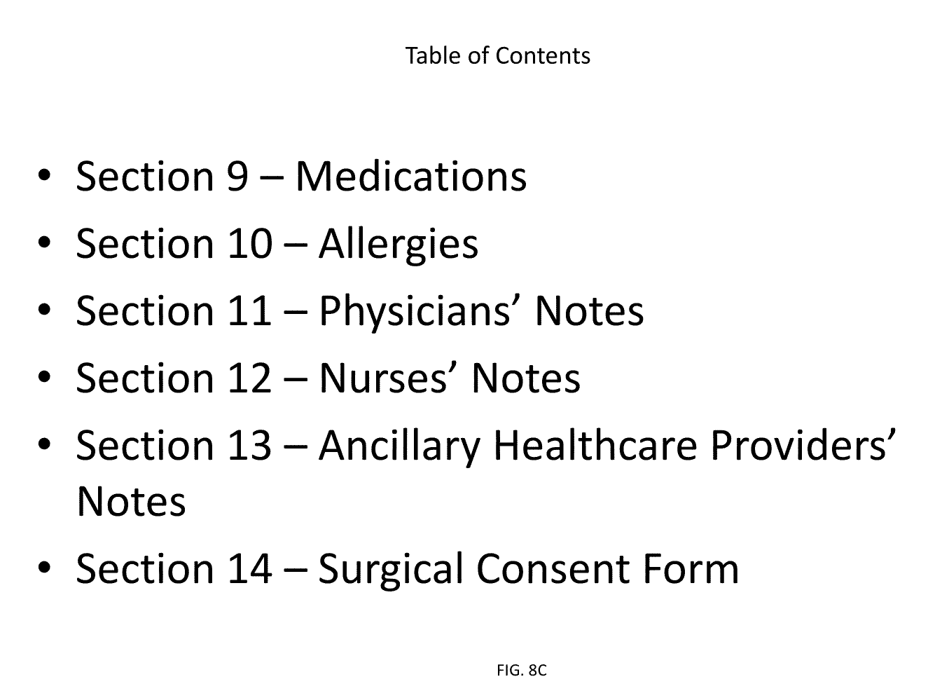

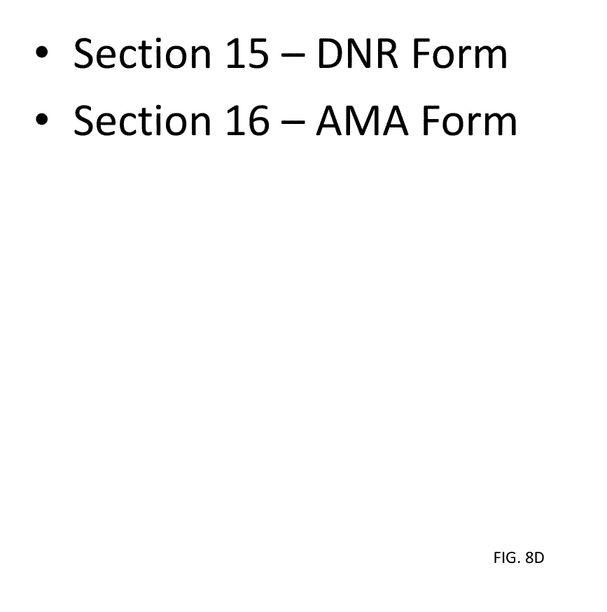

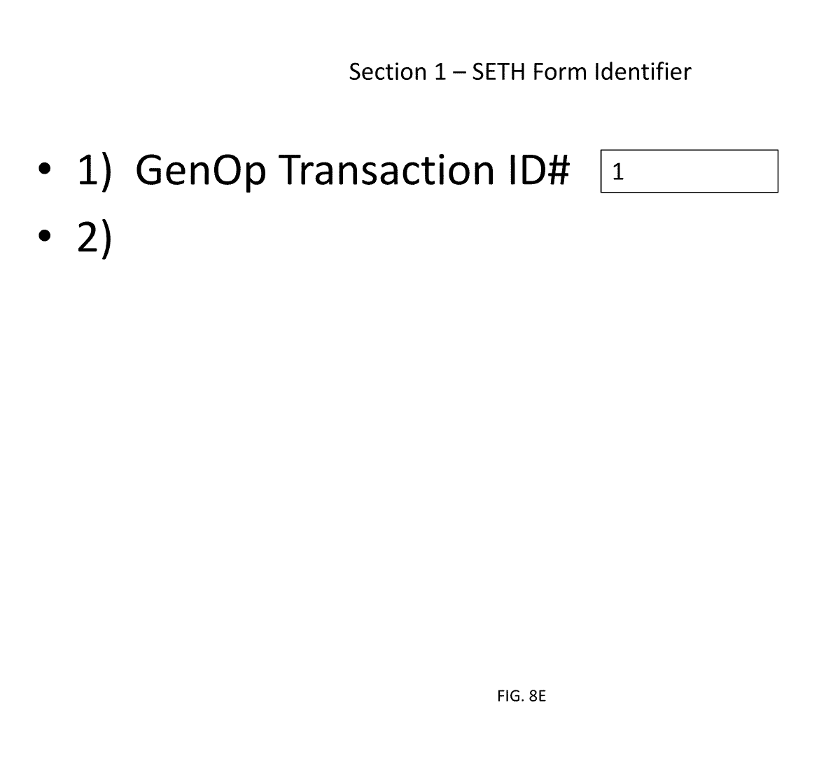

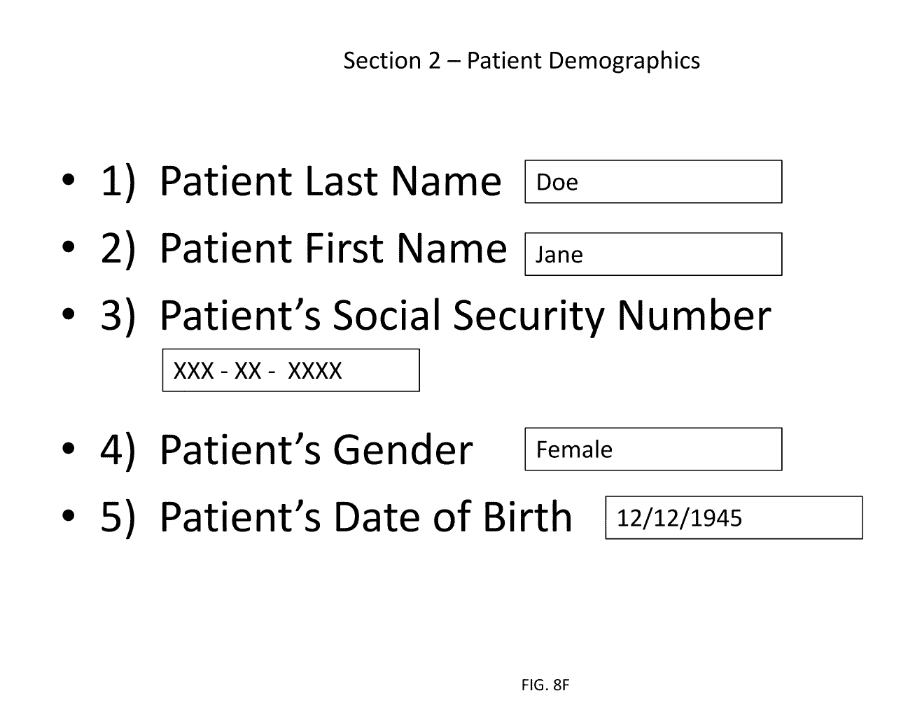

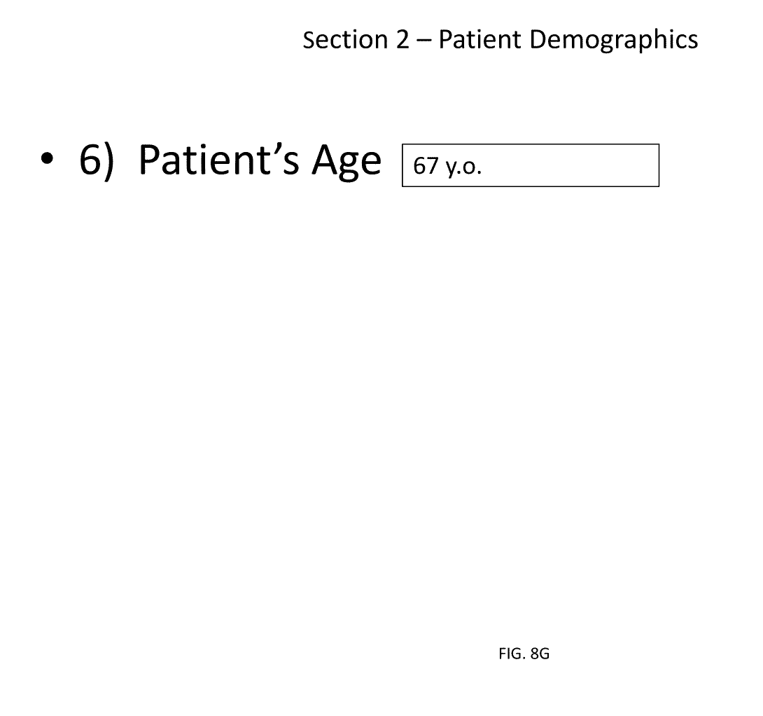

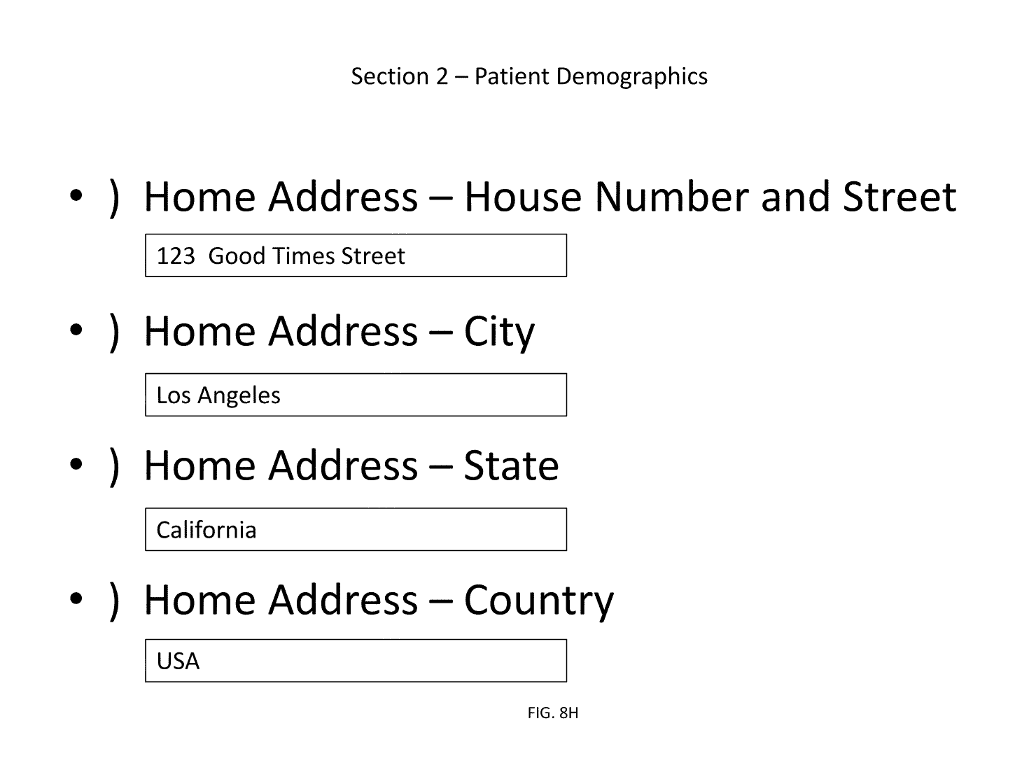

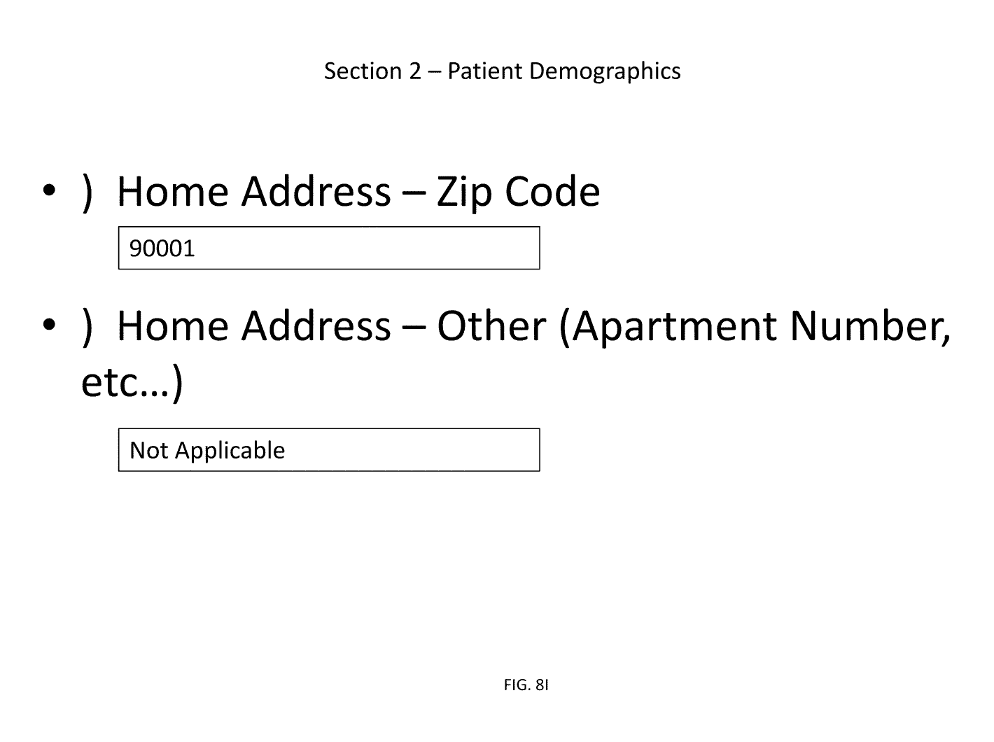

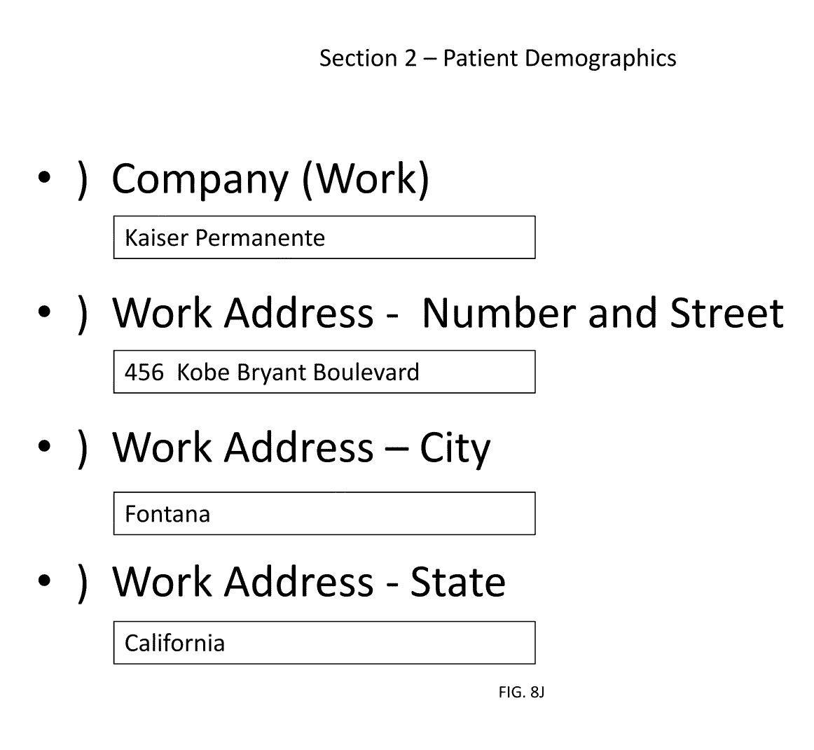

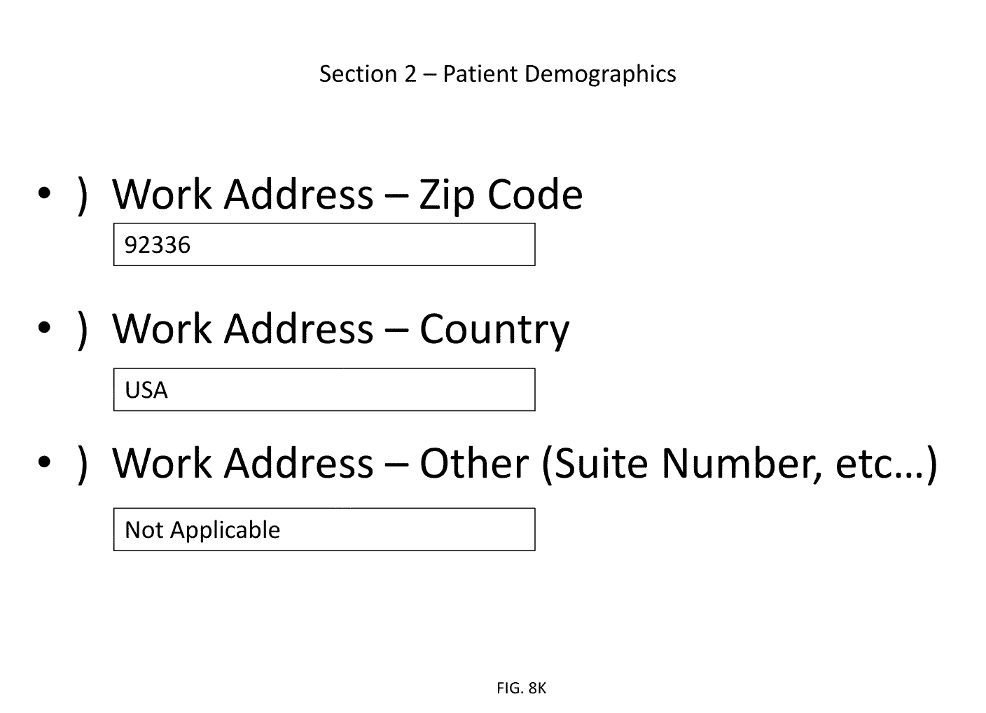

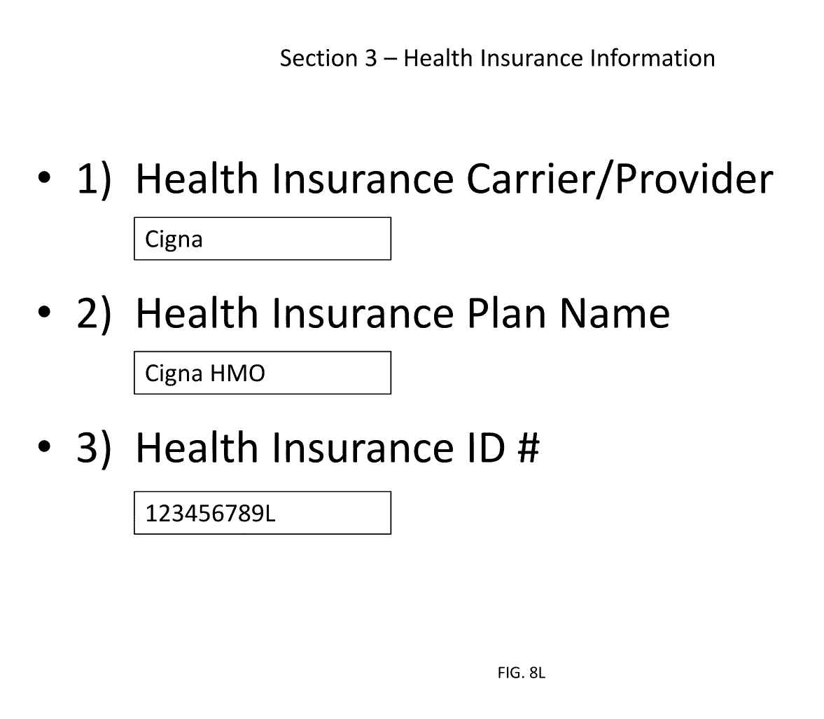

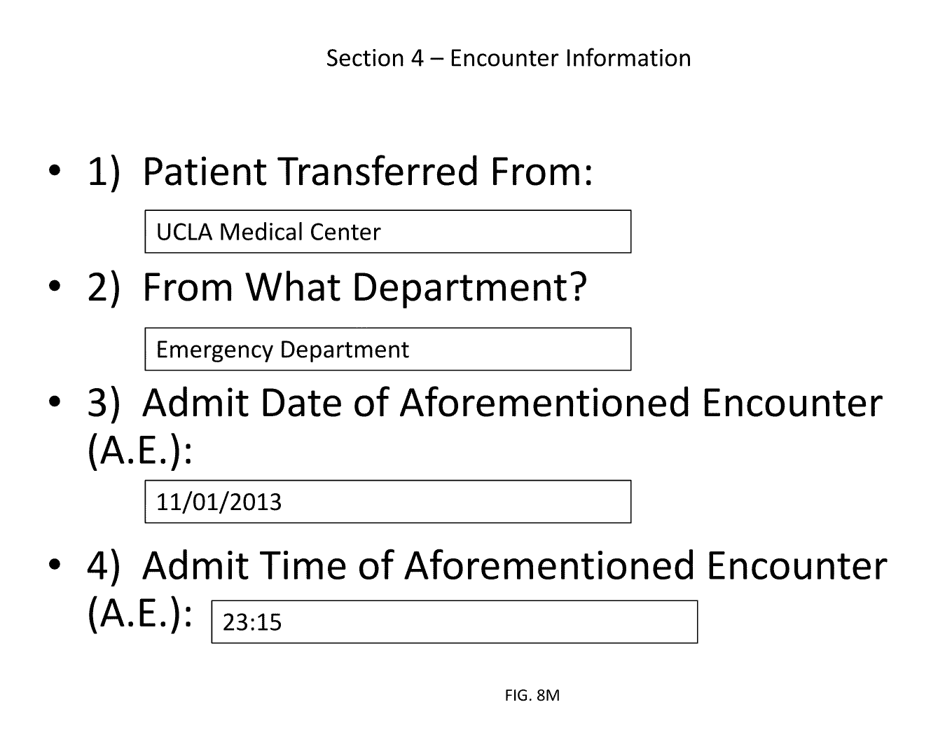

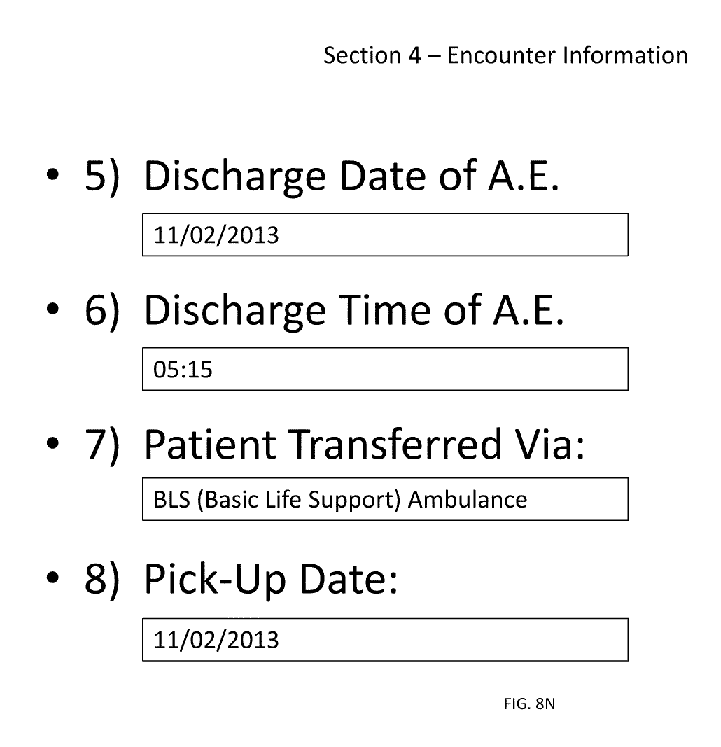

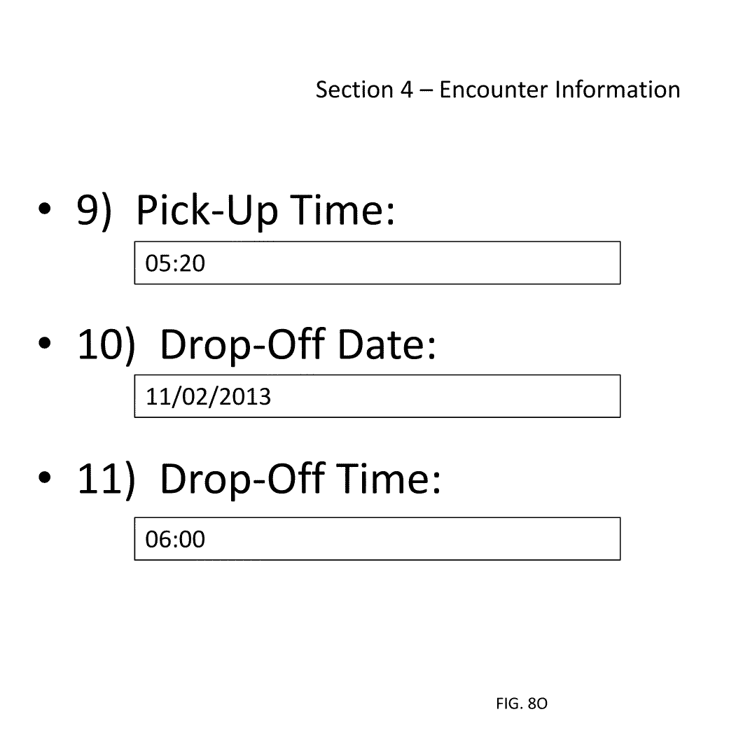

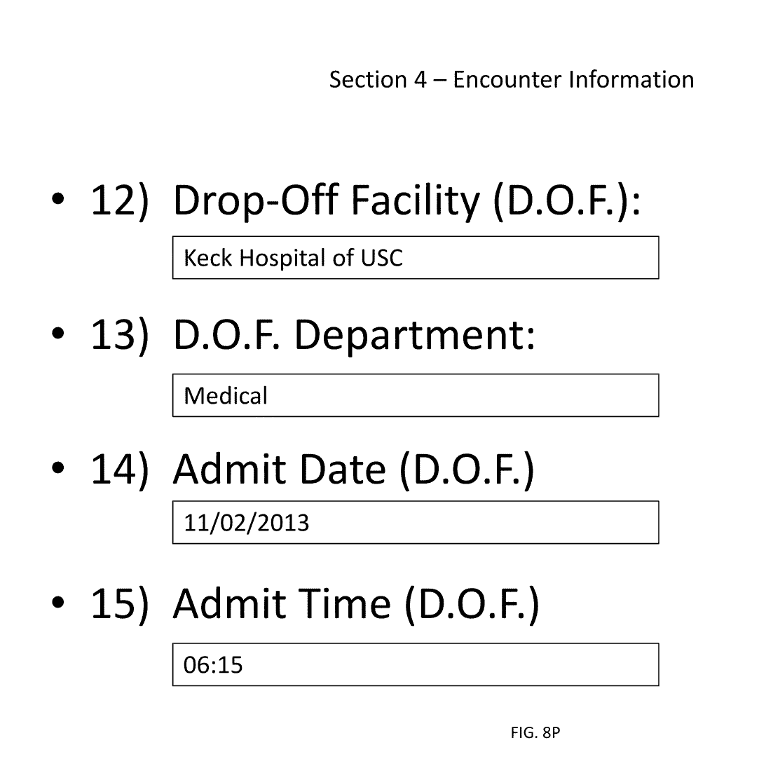

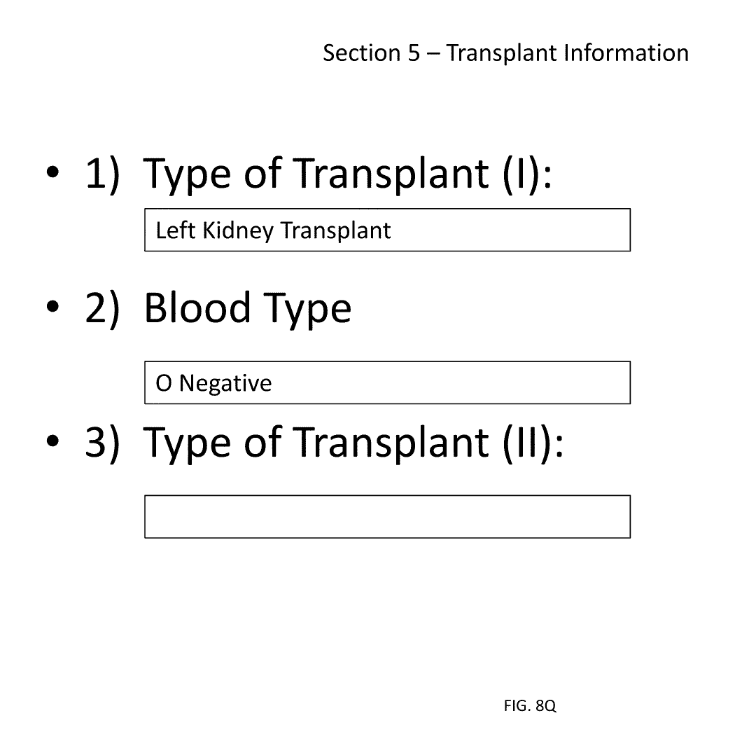

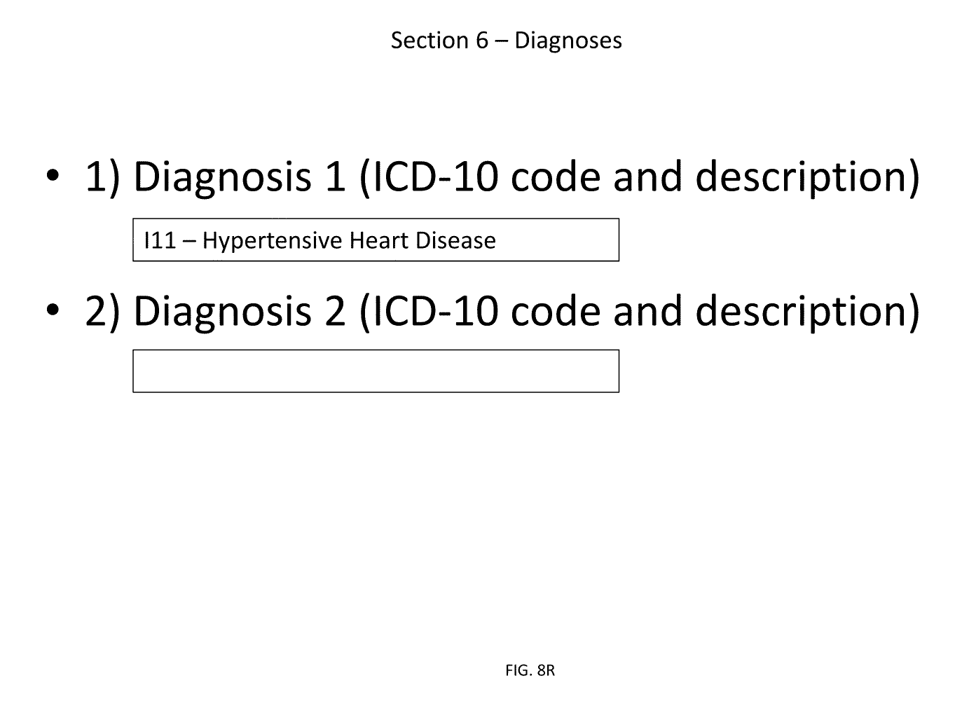

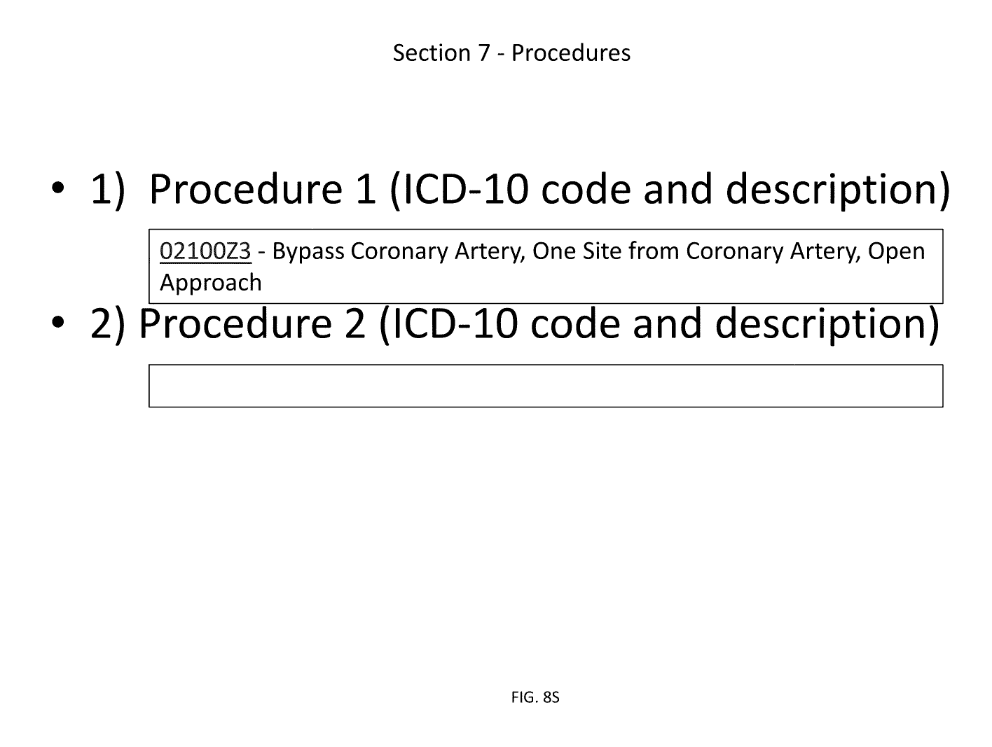

In FIG. 8A-8S, exemplary fields of a SETH Form are illustrated. As mentioned previously, SETH Forms may be embedded with skip logic, thus not all fields may be shown if they are irrelevant to the query. Furthermore, the data owner has control over which field that they may wish to send or push to the data requestor/receiver. It may also be possible that the United States Government or a dully appointed governing body may mandate the required contents of the SETH Form. Thus FIG. 8A-8S are shown for the purposes of example only and should not be considered limiting the invention only to those fields shown.

### CONCLUSION

While this specification includes many specifics, these should not be construed as limitations on the scope of the disclosure or of what may be claimed, but rather as descriptions of features specific to particular implementations of the disclosure. For example, embodiments of the invention have been described as transferring data between two HCFs. The invention, however, is not limited to transfer between only two HCFs and may be applied to multiple HCFs. The use of only two HCFs was for illustrative purposes and should not be considered limiting.

Certain features that are described in this specification in the context of separate implementations may also be implemented in combination in a single implementation. Conversely, various features that are described in the context of a single implementation may also be implemented in multiple implementations, separately or in sub-combination. Moreover, although features may be described above as acting in certain combinations and even initially claimed as such, one or more features from a claimed combination may in some cases be excised from the combination, and the claimed combination may be directed to a sub-combination or variations of a sub-combination. Accordingly, the claimed invention is limited only by the claims that follow below.

What is claimed is:

1. A system for transferring patient medical data, comprising:
a first interface module with two-way data transfer and data feedback loop functionality, coupled to and interfaced with a first electronic medical record module of a first healthcare facility;
a wide area network based computer application coupled to the first interface module adapted to receive a first message including information related to a patient's medical records;
a standardized electronic two-way data transfer healthcare form generated and displayed by the web based computer application and populated by at least a part of the information related to the patient's medical records;
a second interface module with two-way data transfer and data feedback loop functionality, coupled to and interfaced with a second electronic medical record module of a second healthcare facility.

2. The system of claim 1, wherein the wide area network based computer application is adapted to detect a request for data from the first healthcare facility.

3. The system of claim 2, wherein in response to the request for data from the first healthcare facility, the wide area network based computer application contacts the second healthcare facility for the requested data and receives the standardized electronic two-way data transfer healthcare form populated with at least a portion of the requested data from the second healthcare facility.

4. The system of claim 3, wherein the first interface module receives the requested data from the wide area network based computer application and updates the first electronic medical record module with the requested data.

5. The system of claim 1, wherein the wide area network based computer application is adapted to detect a request to push data from the first healthcare facility.

6. The system of claim 5, wherein in response to the request to push data from the first healthcare facility, the wide area network based computer application populates the standardized electronic two-way data transfer healthcare form with data related to the patient's medical records and pushes the standardized electronic two-way data transfer healthcare form to the second healthcare facility.

7. The system of claim 1, wherein the first and second interface modules use a Health Level Seven International (HL7) standard.

8. The system of claim 3, wherein the data populating the standardized electronic two-way data transfer healthcare form is selected by the first healthcare facility.

9. The system of claim 6, wherein the data populating the standardized electronic two-way data transfer healthcare form is selected by the first healthcare facility.

10. A method of transferring patient medical data, comprising:
receiving at a wide area network based computer application a request for data relating to a patient's medical records;
translating, at a first interface module with two-way data transfer and data feedback loop functionality coupled to and interfaced with a first electronic medical record module of a first healthcare facility, at least a part of the requested data relating to a patient's medical records;
selectively populating a standardized electronic two-way data transfer healthcare form with at least a part of the requested data relating to a patient's medical records at a wide area network based computer application;
receiving, at a second interface module with two-way data transfer and data feedback loop functionality, coupled to and interfaced with a second electronic medical record module of a second healthcare facility, the selectively populating a standardized electronic two-way data transfer healthcare form;
translating, at the second interface module the patient medical record data in the selectively populated standardized electronic two-way data transfer healthcare form;
updating the electronic medical record module of a second healthcare facility with the translated patient medical record data in the selectively populated standardized electronic two-way data transfer healthcare form.

11. The method of claim 10, wherein the first and second interface modules use a Health Level Seven International (HL7) standard.

12. The method of claim 10, wherein the data populating the standardized electronic two-way data transfer healthcare form is selected by the first healthcare facility.

13. A method of transferring patient medical data, comprising:
receiving, at a wide area network based computer application a request to send patient medical record data from a first interface module with two-way data transfer and data feedback loop functionality coupled to and interfaced with a first electronic medical record module of a first healthcare facility;
selectively populating a standardized electronic two-way data transfer healthcare form with patient medical record data from a first interface module;
displaying at the wide area network based computer application the selectively populated standardized electronic two-way data transfer healthcare form;
sending the selectively populated standardized electronic two-way data transfer healthcare form to a second interface module with two-way data transfer and data feedback loop functionality, coupled to and interfaced with a second electronic medical record module of a second healthcare facility;
translating, at the second interface module, the patient medical record data in the selectively populated standardized electronic two-way data transfer healthcare form;
updating the electronic medical record module of the second healthcare facility with the translated patient medical record data in the selectively populated standardized electronic two-way data transfer healthcare form

14. The method of claim 13, wherein the first and second interface modules use a Health Level Seven International (HL7) standard.

15. The method of claim 13, wherein the data populating the standardized electronic two-way data transfer healthcare form is selected by the first healthcare facility.
